(19) United States
(12) Patent Application Publication
(10) Pub. No.: US 2026/0167202 A1
(43) Pub. Date: Jun. 18, 2026

(54) METHOD FOR OPERATING A VEHICLE, COMPUTER PROGRAM PRODUCT, CONTROL SYSTEM AND VEHICLE

(71) Applicant: VALEO SCHALTER UND SENSOREN GMBH, Bietigheim-Bissingen (DE)

(72) Inventors: Ashwin-Dayal George, Bietigheim-Bissingen (DE); Youssef-Aziz Ghaly, Bietigheim-Bissingen (DE); Ashraf Nabil, Cairo (EG)

(73) Assignee: VALEO SCHALTER UND SENSOREN GMBH, Bietigheim-Bissingen (DE)

(21) Appl. No.: 18/720,457

(22) PCT Filed: Dec. 8, 2022
(86) PCT No.: PCT/EP2022/084899

§ 371 Date: Jun. 14, 2024

(30) Foreign Application Priority Data
Dec. 14, 2021 (DE) 10 2021 132 925.6

(51) Int. Cl. B60W 40/04; B60W 30/12; B60W 30/16; B60W 30/18; B60W 50/14; G06V 20/56

(52) U.S. Cl. CPC B60W 40/04; B60W 30/12; B60W 30/16; B60W 30/18163; B60W 50/14; G06V 20/588; B60W 2554/802

(57) ABSTRACT

A method for operating an ego-vehicle includes receiving sensor data of a sensor system of the ego-vehicle and detecting an absence of lane markings and a presence of a preceding vehicle based on the sensor data. The method also includes determining a virtual lane based on a heading angle of the preceding vehicle and a lateral distance between the ego-vehicle and the preceding vehicle derived from the sensor data, and performing a lane keeping assistant function to keep the ego-vehicle on the virtual lane.

The present invention relates to a method for operating a vehicle, a computer program product, a control system and a vehicle with such a control system.

Modern vehicles, such as passenger vehicles, are nowadays usually equipped with several driver assistant systems. An example is a lane keeping system which detects a lane of a road on which a vehicle is driving based on sensor data and positions the vehicle within the delineations of the lane. Lane keeping systems rely primarily on the detection of lane markings on the road. A problem occurs if no lane markings are present on the road. US 2019 382 008 A1 proposes to generate a virtual lane in cases in which no lane markings are detected based on an extrapolation of the last detected lane markings and position the vehicle within the delineations of the virtual lane.

It is one object of the present invention to provide an improved method for operating a vehicle.

Accordingly, a method for operating a vehicle is provided. The method comprises the steps:
receiving sensor data of a sensor system of the vehicle,
detecting an absence of lane markings and a presence of a preceding vehicle based on the sensor data,
determining a virtual lane based on a heading angle of the preceding vehicle and a lateral distance between the ego-vehicle and the preceding vehicle derived from the sensor data, and
performing a lane keeping assistant function to keep the ego-vehicle on the virtual lane.

Thus, a robust method for operating a lane keeping system is provided. In particular, by determining a virtual lane based on a detected preceding vehicle, a lane keeping assistant function can be provided also in cases in which no lane markings are detected in the sensor data. In particular, the ego-vehicle can follow a virtual lane which is calculated based on a movement of the preceding vehicle. The movement of the preceding vehicle is detected by measuring a heading angle of the preceding vehicle with respect to the ego-vehicle based on the sensor data. Further, the movement of the preceding vehicle is detected by measuring a lateral distance between the ego-vehicle and the preceding vehicle based on the sensor data. Hence, the ego-vehicle can follow a virtual lane which takes the movement of the preceding vehicle into account. This includes cases in which the ego-vehicle does not strictly follow the movement of the preceding vehicle.

The method steps are, in particular, carried out by a control system of the vehicle.

The preceding vehicle is, in particular, a preceding vehicle on the same lane as the ego-vehicle. The presence of the preceding vehicle is, for example, detected already in a state in which lane markings were still present. Further, the control system may, for example, determine a suitability of the preceding vehicle as a target for a lane keeping assistant function based on a lateral and longitudinal distance between the ego-vehicle and the preceding vehicle.

The heading angle of the preceding vehicle is, in particular, an angle of the current travel direction of the preceding vehicle with respect to an angle of the current travel direction of the ego-vehicle.

The lateral distance between the ego-vehicle and the preceding vehicle is, in particular, a distance between the ego-vehicle and the preceding vehicle perpendicular to a direction of an extrapolation of previously present lane markings. The lateral distance between the ego-vehicle and the preceding vehicle is, for example, a lateral distance between a central lateral position of the ego-vehicle and a central lateral position of the preceding vehicle.

The sensor system of the vehicle (ego-vehicle) is, in particular, an environmental sensor system comprising one or more environmental sensor units. The sensor units are configured to detect a driving state of the vehicle and an environment of the vehicle. Examples of such sensor units are a camera device for capturing images of the surrounding, a radar device (radio detection and ranging) for obtaining radar data and a lidar device (light detection and ranging) for obtaining lidar data. The sensor system may in addition include ultrasonic sensors, location sensors, wheel angle sensors and/or wheel speed sensors. The sensor units are each configured to output a sensor signal, for example to a driving assistance system or a parking assistance system, which for example performs assisted or (semi-) autonomous driving as a function of the detected sensor signals. In particular, the sensor units can each be configured to output a sensor signal to the control system and/or the lane keeping system, which performs automatic lane keeping control as a function of the detected sensor signals.

For example, the presence or absence of lane markings of a road may be detected based on images (as an example of sensor data) of a camera device of the vehicle. The camera device is, for example, a front camera arranged at the front windscreen of the vehicle and configured to monitor an area in front of the vehicle. However, the camera device may also be arranged at a different window of the vehicle and/or monitor a different area, e.g., behind the vehicle in a case in which also a vehicle following the ego-vehicle is detected.

For example, the presence of a preceding vehicle may be detected based on images of a camera device of the vehicle, such as a front camera. Alternatively or in addition, the presence of a preceding vehicle may also be detected based on radar and/or lidar data (as an example of sensor data) of a radar and/or lidar device of the vehicle.

For example, the heading angle of the preceding vehicle with respect to the heading angle of the ego-vehicle may be measured based on image data of a camera device, radar data of a radar device and/or lidar data of a lidar device of the vehicle. Further, the lateral distance between the ego-vehicle and preceding vehicle may be measured based on image data of a camera device, radar data of a radar device and/or lidar data of a lidar device of the vehicle.

The control system is, for example, outputting an instruction to a steering system of the ego-vehicle in accordance with the determined virtual lane. The instruction is, for example, an instruction to steer towards a center line of the virtual lane.

The vehicle (ego-vehicle) is, for example, a passenger car, a van or a truck. The vehicle is, for example, configured for assisted, semi-autonomous and/or fully autonomous driving. A level of automatization of the vehicle is, for example, any of a level 1 or 2 (hands-on system) to a level 5 (fully automatic). Said levels 1 to 5 correspond to the SAE classification system published in 2014 from SAE International as J3016 (“Taxonomy and Definitions for Terms Related to On-Road Motor Vehicle Automated Driving Systems”).

According to an embodiment, determining the virtual lane includes determining a center line of the virtual lane such that a lateral distance between the ego-vehicle and the center line has a value which is a fraction of the lateral distance between the ego-vehicle and the preceding vehicle.

For example, determining the virtual lane includes determining a center line of the virtual lane such that a lateral distance between the ego-vehicle and the center line has a value of half (50%) of the lateral distance between the ego-vehicle and the preceding vehicle. Other possible values for said fraction are, for example, 90%, 75% and 25% of the lateral distance between the ego-vehicle and the preceding vehicle.

By using a fraction of the lateral distance between the ego-vehicle and the preceding vehicle—for example, taking the arithmetic mean of the current lateral positions of the ego-vehicle and the preceding vehicle—for determining the virtual lane, the lane keeping assistant function can be performed such that the ego-vehicle does not exactly follow the movement of the preceding vehicle. Rather, the ego-vehicle follows a line (center line of the virtual lane) that is laterally between—for example, a middle path with respect to—the lateral position of the ego-vehicle and the preceding vehicle.

The lateral distance between the ego-vehicle and the center line of the virtual lane is, for example, a lateral distance between a central lateral position of the ego-vehicle and the center line of the virtual lane.

The center line starts, for example, at a front end (e.g., a front bumper) of the ego-vehicle and extends at least to a back end (e.g., a back bumper) of the preceding vehicle.

According to a further embodiment, a longitudinal distance between the ego-vehicle and the preceding vehicle is determined based on the sensor data. Furthermore, determining the virtual lane includes determining an angle of a center line of the virtual lane as a function of the heading angle of the preceding vehicle such that
for a longitudinal distance between the ego-vehicle and the preceding vehicle below a predetermined longitudinal threshold, the angle of the center line of the virtual lane is equal to the heading angle or to a first fraction of the heading angle of the preceding vehicle, and
for a longitudinal distance between the ego-vehicle and the preceding vehicle equal to or above the predetermined threshold, the angle of the center line of the virtual lane is equal to a second fraction of the heading angle of the preceding vehicle, the second fraction being smaller than the first fraction.

Thus, the determined angle of the center line of the virtual lane depends in addition to the heading angle of the preceding vehicle also on the longitudinal distance between the ego-vehicle and the preceding vehicle. In particular, in the case that the preceding vehicle is very close in front of the ego-vehicle, the virtual lane follows the heading angle of the preceding vehicle more strictly. On the other hand, in the case that the preceding vehicle is far away (in terms of longitudinal distance) from the ego-vehicle, the influence of the heading angle of the preceding vehicle on the determined virtual lane is smaller. Hence, the lane keeping assistant function can be performed such that the ego-vehicle follows the movement of the preceding vehicle less strictly when the preceding vehicle is further away (in terms of longitudinal distance).

The angle of the center line of the virtual lane is, for example, the angle of the center line of the virtual lane at the longitudinal position of the preceding vehicle.

The longitudinal distance between the ego-vehicle and the preceding vehicle is, for example, a longitudinal distance between a front end (e.g., front bumper) of the ego-vehicle and a back end (e.g., back bumper) of the preceding vehicle.

The threshold of the longitudinal distance has, for example, a value of 15 meter, 20 meter, 25 meter, 30 meter or 40 meter. The first fraction has, for example, a value of 0.9, 0.8, 0.7, 0.6 or 0.5.

According to a further embodiment, determining the virtual lane further includes determining the angle of the center line of the virtual lane as a function of the heading angle of the preceding vehicle such that
for a longitudinal distance between the ego-vehicle and the preceding vehicle above a predetermined further longitudinal threshold, the angle of the center line of the virtual lane is equal to a third fraction of the heading angle of the preceding vehicle, the further longitudinal threshold being larger than the longitudinal threshold and the third fraction being smaller than the second fraction.

The threshold of the longitudinal distance has, for example, a value of 15 meter, 20 meter or 25 meter, and the further longitudinal threshold has, for example, a value of 35 meter, 40 meter or 45 meter. The second fraction has, for example, a value of 0.95, 0.9 or 0.8, and the third fraction has, for example, a value of 0.7, 0.6 or 0.5.

According to a further embodiment, determining the virtual lane includes:
determining a center line of the virtual lane such that a lateral distance between the ego-vehicle and the center line is a function of the lateral distance between the ego-vehicle and the preceding vehicle, and
determining left and right delineations of the virtual lane such that a lateral position of each of the left and right delineations is laterally offset from the center line in the left and right directions, respectively, by an offset value that is based on the lateral distance between the ego-vehicle and the center line of the virtual lane.

Thus, a width of the virtual lane is determined depending on the lateral distance between the ego-vehicle and the center line of the virtual lane. For example, for a decreasing lateral distance between the ego-vehicle and the preceding vehicle and, thus, a decreasing lateral distance between the ego-vehicle and the center line of the virtual lane (in other words, for the ego-vehicle's path converging towards the center line of the virtual lane), the width of the virtual lane is also decreasing.

According to a further embodiment, the offset value W is given by

$$W = min ( K , L 3 ) ,$$

wherein K is a predetermined value corresponding to half of a width of a standard lane, and L3 is a calculated lateral distance which is the sum of the lateral distance between the ego-vehicle and the center line of the virtual lane and a width of the ego-vehicle or a fraction of the width of the ego-vehicle.

K has, for example, a value in the range of 1.5 to 2 meters. K has, for example, a value of 1.75 meters.

The fraction of the width of the ego-vehicle is, for example, a fraction in the range of 0.6 to 0.95. The fraction of the width of the ego-vehicle is, for example, a fraction of 0.8.

According to a further embodiment, the lane keeping assistant function is performed such that
determining the virtual lane is repeatedly performed to keep the ego-vehicle on the repeatedly updated virtual lane,
determining the virtual lane is repeatedly performed based on a repeatedly updated heading angle of the preceding vehicle and a repeatedly updated lateral distance between the ego-vehicle and the preceding vehicle determined from repeatedly received sensor data until the determined lateral distance between the ego-vehicle and the preceding vehicle has decreased to a predetermined lateral threshold, and then
determining the virtual lane is repeatedly performed based on a repeatedly updated heading angle of the preceding vehicle and a lateral distance between the ego-vehicle and the preceding vehicle being equal to the predetermined lateral threshold.

Due to the lane keeping assistant function keeping the ego-vehicle on the virtual lane, the ego-vehicle moves laterally closer to the center line of the virtual lane and, thus, to the preceding vehicle. During this procedure, the lateral distance to the center line of the virtual lane is reduced and the offset value W representing the width of the virtual lane is also reduced.

When the actual lateral distance between the ego-vehicle and the preceding vehicle has decreased to the predetermined lateral threshold, the virtual lane is no longer determined based on the measured lateral distance between the ego-vehicle and the preceding vehicle but instead is determined based on a “frozen” (constant) lateral distance being equal to the predetermined lateral threshold. Therefore, from then on, the lane keeping assistant function will not cause the ego-vehicle to move laterally closer to the preceding vehicle. Thus, the lane keeping function is performed so as to restrict the degree to which the ego-vehicle follows the preceding vehicle in terms of lateral distance. Hence, when the preceding vehicle is, for example, swerving with a lateral component of the swerving movement being smaller than the predetermined lateral threshold, the ego-vehicle will not take part in this swerving movement.

The repeatedly received sensor data are, in particular, repeatedly received while the ego-vehicle is driving. The repeatedly received sensor data are, for example, continuously received.

According to a further embodiment, when the determined lateral distance between the ego-vehicle and the preceding vehicle is increasingly reaching a further predetermined lateral threshold, the further predetermined lateral threshold being larger than the predetermined lateral threshold, determining the virtual lane is started again based on the repeatedly updated heading angle of the preceding vehicle and the repeatedly updated lateral distance between the ego-vehicle and the preceding vehicle determined from the repeatedly received sensor data.

Thus, the control system takes the lateral distance to the preceding vehicle based on a hysteresis into account when determining the virtual lane, as there are two different lateral thresholds (predetermined lateral threshold and further predetermined lateral threshold) for the two cases of approaching the respective threshold in a decreasing manner or in an increasing manner. In other words, when the first lateral threshold has been reached by decreasingly approaching the first lateral threshold, the control system stops determining the virtual lane again based on the repeatedly updated lateral distance between the ego-vehicle and the preceding vehicle but uses a frozen lateral distance. Further, the control system only starts determining the virtual lane again based on the repeatedly updated lateral distance between the ego-vehicle and the preceding vehicle when the second lateral threshold has been reached by increasingly approaching the second lateral threshold.

The lateral threshold has, for example, a value in the range of 0.1 to 0.2 meter and/or the further lateral threshold has, for example, a value in the range of 0.3 to 0.5 meter.

According to a further embodiment, a lateral speed of the preceding vehicle is determined based on the sensor data, and performing the lane keeping assistant function is stopped when the determined lateral speed is above a lateral speed threshold and/or a variation of the heading angle of the preceding vehicle is above a predetermined threshold.

Thus, the lane keeping assistant function based on the preceding vehicle is stopped in case that the preceding vehicle is making a sudden change in its current trajectory, e.g., a lane change.

In embodiments, detection of a sudden change in the current trajectory of the preceding vehicle can be based—in addition or instead of on the lateral speed of the preceding vehicle—also on a sudden change in the heading angle of the preceding vehicle determined from the sensor data (e.g., a variation/speed of the heading angle being above a predetermined threshold).

According to a further embodiment, more than one preceding vehicle and/or one or more following vehicles on the same lane as the ego-vehicle and in a predetermined region of interest are detected based on the sensor data. Furthermore, the virtual lane is determined based on a heading angle of each of the more than one preceding vehicles and/or the one or more following vehicles and based on a lateral distance between the ego-vehicle and each of the more than one preceding vehicles and/or the one or more following vehicles derived from the sensor data.

Thus, the virtual lane can be determined based on the movement of more than one other vehicle.

According to a further embodiment, the virtual lane is determined based on a mean value and/or a weighted mean value of the heading angles of the more than one preceding vehicles and/or the one or more following vehicles and based on a mean value and/or a weighted mean value of the lateral distances between the ego-vehicle and each of the more than one preceding vehicles and/or the one or more following vehicles derived from the sensor data.

Hence, the virtual lane can be better estimated and is less dependent on the movement of a single other vehicle.

According to a further embodiment, the weights applied for determining the weighted mean value of the heading angles and/or of the lateral distances are chosen such that a smaller lateral distance corresponds to a higher weight.

According to a second aspect, a computer program is provided. The computer program comprises instructions which, when the program is executed by a computer, cause the computer to carry out the above-described method.

A computer program (computer program product), such as a computer program means, may be embodied as a memory card, USB stick, CD-ROM, DVD or as a file which may be downloaded from a server in a network. For example, such a file may be provided by transferring the file comprising the computer program product from a wireless communication network.

According to a third aspect, a control system for a vehicle is provided. The control system is configured to perform the above-described method.

The control system is, for example, a lane keeping system or is part of a lane keeping system.

According to a fourth aspect, a vehicle with an above-described control system is provided.

The respective above or below described entities, e.g. the control system, a receiving unit, a detecting unit, a determining unit, a lane keeping unit, an output unit, may be implemented in hardware and/or in software. If said entity is implemented in hardware, it may be embodied as a device, e.g. as a computer or as a processor or as a part of a system, e.g. a computer system. If said entity is implemented in software it may be embodied as a computer program product, as a function, as a routine, as an algorithm, as a program code, part of a program code or as an executable object. Furthermore, each of the entities mentioned above can also be designed as part of a higher-level control system of the vehicle, such as a central electronic control unit (ECU).

The embodiments and features described with reference to the method of the present invention apply mutatis mutandis to the computer program product, the control system and the vehicle of the present invention.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

Further embodiments, features and advantages of the present invention will become apparent from the subsequent description and dependent claims.

In the following, the invention will be described in detail based on preferred embodiments with reference to the following figures.

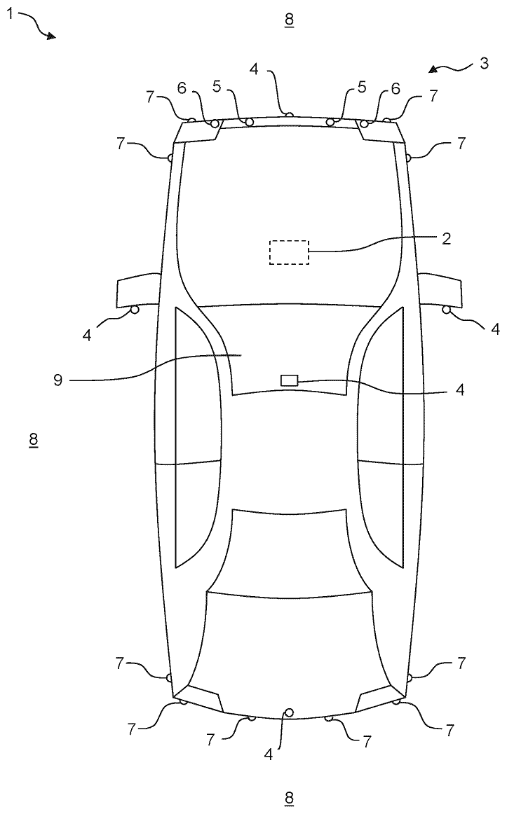

FIG. 1 shows a top view of a vehicle according to an embodiment;

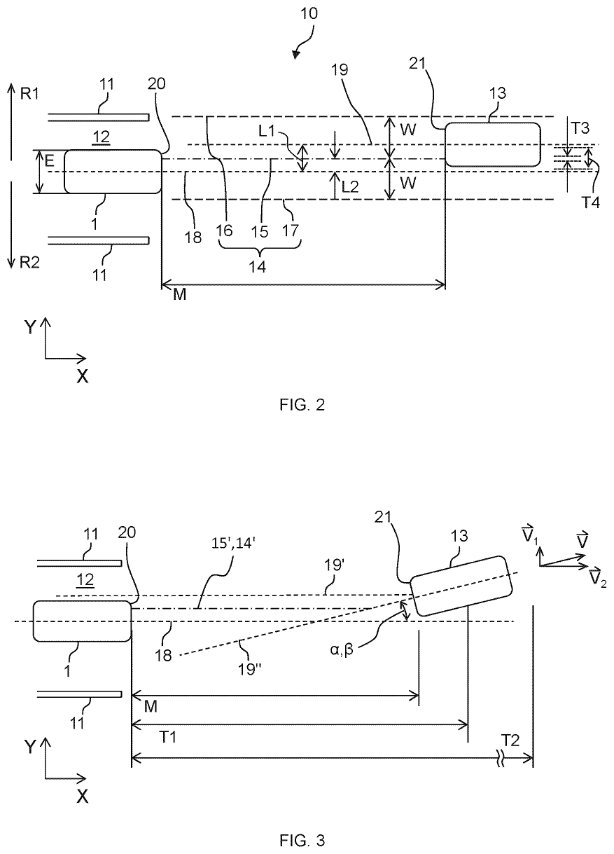

FIG. 2 shows the vehicle of FIG. 1 and a preceding vehicle on a road;

FIG. 3 shows a view similar as FIG. 2 but with another orientation of the preceding vehicle;

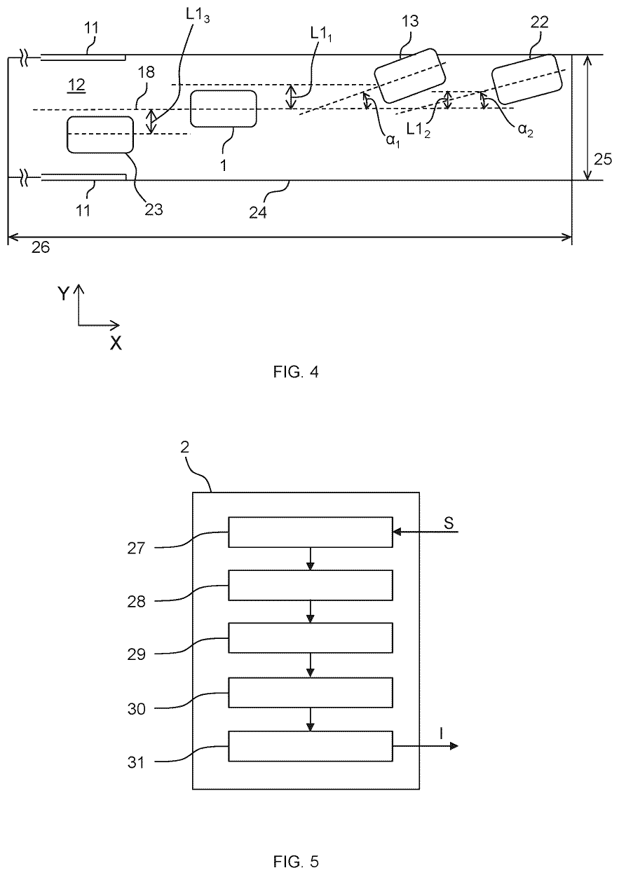

FIG. 4 shows a view similar as FIG. 2 but with two preceding vehicles and one following vehicle;

FIG. 5 shows a control system of the vehicle of FIG. 1; and

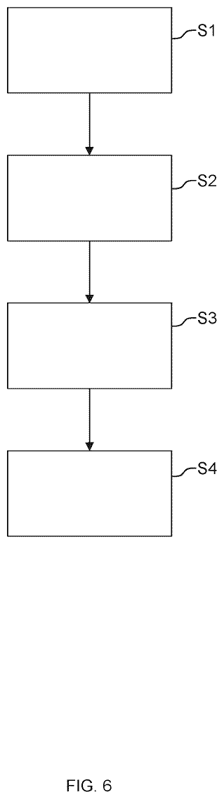

FIG. 6 shows a flowchart illustrating a method for operating the vehicle of FIG. 1.

In the figures, like reference numerals designate like or functionally equivalent elements, unless otherwise indicated.

FIG. 1 shows a schematic top view of a vehicle 1. The vehicle 1 is, for example, a passenger vehicle. The vehicle 1 may also be another kind of vehicle such as a van or truck. The vehicle 1 comprises a control system 2 for controlling the vehicle 1. The control system 2 is, in particular, a lane keeping system.

The vehicle 1 further comprises an electronically controllable steering system (not shown). The control system 2 is configured to send instructions I (FIG. 5) to the steering system for lane keeping purposes.

As shown in FIG. 1, the vehicle 1 comprises a sensor system 3 including several environmental sensor units 4, 5, 6, 7 arranged at the vehicle 1. The sensor system 3 comprise, in particular, one or more camera devices 4 such as one or more front camera devices. The camera devices 4 are configured for obtaining image data of a surrounding 8 of the vehicle 1 and for sending the image data or results of an image analysis of the image data to the control system 2. The front camera device 4 is attached to a front windscreen 9 of the vehicle 1.

The sensor system 3 further comprise, for example, one or more radar devices 5 for obtaining radar data of the surrounding 8 of the vehicle 1. The sensor system 3 may further comprise, for example, one or more lidar devices 6 for obtaining lidar data of the surrounding 8 of the vehicle 1.

The sensor system 3 may comprise further sensors such as ultrasonic sensors 7, one or more rain sensors and/or one or more light sensors (not shown).

In the following, a method for operating the vehicle 1 will be described with reference to FIGS. 2 to 6. The method is, in particular, a method for performing a lane keeping assistant function.

FIG. 2 shows the vehicle 1 of FIG. 1 on a road 10. There are lane markings 11 on the road 10 delineating a lane 12 on which the vehicle 1 is driving. When the lane keeping system (control system 2) is active, the lane markings 11 are detected by means of the sensor system 3 (FIG. 1) of the vehicle 1. In particular, the lane markings 11 are detected by means of the front camera device(s) 4. Further, a lane keeping function is performed by the control system 2 so as to keep the vehicle 1 on the lane 12.

As shown in FIG. 2, the vehicle 1 is entering an area of the road 10 where there are no lane markings (such as the lane markings 11) present.

In a first step S1 of the method, the control system 2 of the vehicle 1 receives sensor data S (FIG. 5) of the sensor system 3 (FIG. 1) of the vehicle 1. The sensor data S comprise, in particular, data from a camera device 4 (FIG. 1) of the vehicle 1. The sensor data S may also comprise, for example, data from a radar device 5 and/or data from a lidar device 6 of the vehicle 1. The control system 2 comprises, for example, a receiving unit 27 (FIG. 5) for receiving the sensor data S from the sensor system 3.

In a second step S2 of the method, the control system 2 detects an absence of lane markings (such as the lane markings 11) and a presence of a preceding vehicle 13 (FIG. 2) based on the sensor data S. The control system 2 comprises, for example, a detecting unit 28 (FIG. 5) for detecting the absence of lane markings and the presence of a preceding vehicle 13 based on the sensor data S.

In a third step S3 of the method, the control system 2 of the vehicle 1 (ego-vehicle 1) determines a virtual lane 14, 14′ (FIGS. 2, 3) taking into account a movement of the preceding vehicle 13. The control system 2 determines the virtual lane 14, 14′, in particular, by determining a center line 15, 15′ of the virtual lane 14, 14′ and by determining an angle β (FIG. 3) of the center line 15, 15′. Furthermore, left and right delineations 16, 17 (FIG. 2) of the virtual line 14, 14′ are determined. The left and right delineations 16, 17 are, in particular, left and right virtual delineations 16, 17. The control system 2 comprises, for example, a determining unit 29 (FIG. 5) for determining the virtual lane 14, 14′.

In detail, for determining the center line 15,15′ of the virtual lane 14, 14′, the control system 2 (e.g., the determining unit 29) measures a lateral distance L1 between the ego-vehicle 1 and the preceding vehicle 13 based on the sensor data S of the sensor system 3 (FIG. 1), in particular based on the sensor data S of the camera devices 4, the radar devices 5 and/or of the lidar devices 6. A longitudinal direction in FIG. 2 is denoted with X and a lateral direction with Y. The lateral distance L1 is, for example, a lateral distance L1 between a central lateral position 18 of the ego-vehicle 1 and a central lateral position 19 of the preceding vehicle 13. The control system 2 determines the center line 15, 15′ of the virtual lane 14, 14′ such that a lateral distance L2 between the ego-vehicle 1 and the center line 15, 15′ has a value of half of the lateral distance L1 between the ego-vehicle 1 and the preceding vehicle 13:

$$L 2 = 0.5 \times L 1.$$

The center line 15, 15′ starts, for example, at a front end 20 (e.g., a front bumper) of the ego-vehicle 1 and extends at least to a back end 21 (e.g., a back bumper) of the preceding vehicle 13 (FIG. 2).

The control system 2 (e.g., the determining unit 29) further determines a heading angle α (FIG. 3) of the preceding vehicle 13 with respect to a heading angle of the ego-vehicle 1 based on the sensor data S of the sensor system 3 (FIG. 1), in particular based on the sensor data S of the camera devices 4, the radar devices 5 and/or of the lidar devices 6. It is noted that the heading angle of the ego-vehicle 1 is zero in FIGS. 2 to 3 and is, therefore, not denoted with a reference sign. It is further noted that for illustration purposes, in FIG. 2 the preceding vehicle 13 is shown in an orientation with a heading angle α of zero and in FIG. 3 with a heading angle α larger than zero. Accordingly, the center line 15 of the virtual lane 14 in FIG. 2 is parallel to a longitudinal direction X. Further, the center line 15′ of the virtual lane 14′ in FIG. 3 is not parallel to the longitudinal direction X but has a curved shape starting at the ego-vehicle 1 with an angle β of zero and ending at the preceding vehicle 13 with an angle β larger than zero (in the shown example of FIG. 3 with an angle β equal to a).

The control system 2 (e.g., the determining unit 29) determines the angle β of the center line 15, 15′ of the virtual lane 14, 14′ as a function of the heading angle α of the preceding vehicle 13. In particular, depending on a longitudinal distance M (FIG. 2) between the ego-vehicle 1 and the preceding vehicle 13, the angle β of the center line 15, 15′ of the virtual lane 14, 14′ is set, for example, equal to the heading angle α of the preceding vehicle 13 (for small longitudinal distances M) or is set to a fraction of the heading angle α of the preceding vehicle 13 (for large longitudinal distances M). The longitudinal distance M between the ego-vehicle 1 and the preceding vehicle 13 is measured by the control system 2 based on the sensor data S of the sensor system 3, in particular of the camera devices 4, the radar devices 5 and/or the lidar devices 6. The angle β of the center line 15, 15′ of the virtual lane 14, 14′ may be determined as a function of the heading angle α of the preceding vehicle 1 based on the following relations:

$$\begin{matrix}β = α & for M < T 1 \\ β = F 1 \times α & for T 1 \leq M \leq T 2 \\ β = F 2 \times α & for M > T 2 and F 2 < F 1\end{matrix} .$$

That means, for a longitudinal distance M between the ego-vehicle 1 and the preceding vehicle 13 below a predetermined first longitudinal threshold T1 (FIG. 3), the angle β of the center line 15, 15′ is set equal to the heading angle α of the preceding vehicle 13. Further, for a longitudinal distance M between the ego-vehicle 1 and the preceding vehicle 13 equal to or above the predetermined first longitudinal threshold T1 and below or equal to a second longitudinal threshold T2, the angle β of the center line 15, 15′ is set equal to a first fraction F1 of the heading angle α of the preceding vehicle 13. Furthermore, for a longitudinal distance M between the ego-vehicle 1 and the preceding vehicle 13 above the predetermined second longitudinal threshold T2, the angle β of the center line 15, 15′ is set equal to a second fraction F2 of the heading angle α of the preceding vehicle 13, the second fraction F2 being smaller than the first fraction F1.

For example:

$$\begin{matrix}β = α & for M < 20 meter \\ β = 0.9 \times α & for 20 meter \leq M \leq 40 meter \\ β = 0.6 \times α & for M > 40 meter\end{matrix} .$$

Next, the control system 2 (e.g., the determining unit 29) determines the left and right delineations 16, 17 (FIG. 2) of the virtual lane 14, 14′. In particular, the left and right delineations 16, 17 are determined such that they have the same curvature as the center line 15, 15′. Further, the left and right delineations 16, 17 are determined such that a lateral position of each of the left and right delineations 16, 17 is laterally offset from the center line 15, 15′ in the left and right directions R1, R2, respectively, by an offset value W. The offset value W is determined based on the lateral distance L2 between the ego-vehicle 1 and the center line 15, 15′ of the virtual lane 14, 14′. For example, the offset value W is determined such that:

$$W = min ( K , L 3 ) .$$

Herein, K is a predetermined value corresponding to half of a width of a standard lane. An example for a value of K is 1.75 meter. Furthermore, L3 is a calculated lateral distance given by the following equation:

$$L 3 = L 2 + ( F 3 * E ) ,$$

wherein L2 is the lateral distance between the ego-vehicle 1 and the center line 15, 15′ of the virtual lane 14, 14′, F3 is a fraction and E is a width of the ego-vehicle 1. An example for a value of the fraction F3 is 0.8.

To summarize, in step S3 the virtual lane 14, 14′ is determined by determining the lateral position of the center line 15, 15′ of the virtual lane 14 and an angle β of the center line 15, 15′. Furthermore, left and right delineations 16, 17 of the virtual lane 14, 14′ are determined.

In step S4 of the method, the control system 2 performs a lane keeping assistant function to keep the ego-vehicle 1 on the virtual lane 14. The control system 2 comprises, for example, a lane keeping unit 30 (FIG. 5) for performing the lane keeping assistant function. The control system 2 further comprises, for example, an output unit 31 (FIG. 5) for outputting instructions I to a steering system (not shown) of the ego-vehicle 1 to steer the ego-vehicle towards the center line 15, 15′ of the determined virtual lane 14, 14′.

In particular, determining the virtual lane 14, 14′ (step S3) is repeatedly performed to keep the ego-vehicle 1 on the repeatedly updated virtual lane 14, 14′. Until the determined lateral distance L1 between the ego-vehicle 1 and the preceding vehicle 13 has decreased to a predetermined lateral threshold T3 (e.g., 0.1 meter) (FIG. 2), the control system 2 determines the virtual lane 14, 14′ repeatedly based on a repeatedly updated heading angle α of the preceding vehicle 13 and a repeatedly updated lateral distance L1 between the ego-vehicle 1 and the preceding vehicle 13. The repeatedly updated heading angle α and the repeatedly updated lateral distance L1 are determined from repeatedly received sensor data S from the sensor system 3. As soon as the determined lateral distance L1 between the ego-vehicle 1 and the preceding vehicle 13 has reached in a decreasing manner the predetermined lateral threshold T3 (e.g., 0.1 meter), the virtual lane 14, 14′ is determined based on a repeatedly updated heading angle α of the preceding vehicle 13 and a “frozen” lateral distance L1 between the ego-vehicle 1 and the preceding vehicle 13. The lateral distance L1 used in the calculation of the virtual lane 14, 14′ is, in particular, kept constant at a value equal to the predetermined lateral threshold T3. Thus, when the preceding vehicle 13 is, for example, swerving with a lateral component of the swerving movement being smaller than the predetermined lateral threshold T3, the ego-vehicle 1 will not follow this swerving movement. Thus, a safety and the functionality of the lane keeping system can be improved.

Furthermore, when the determined lateral distance L1 between the ego-vehicle 1 and the preceding vehicle 13 is increasingly reaching a further predetermined lateral threshold T4 (FIG. 2), the further predetermined lateral threshold T4 being larger than the predetermined lateral threshold T3, the control system 2 starts determining the virtual lane 14, 14′ again based on the repeatedly updated heading angle α of the preceding vehicle 13 and the repeatedly updated lateral distance L1 between the ego-vehicle 1 and the preceding vehicle 13. An example for a value of the further predetermined lateral threshold T4 is 0.4 meter.

That means, when the first lateral threshold T3 (e.g., 0.1 meter) has been reached by decreasingly approaching the first lateral threshold T3, the control system 2 stops determining the virtual lane 14, 14′ based on the repeatedly updated lateral distance L1 between the ego-vehicle 1 and the preceding vehicle 13. Further, the control system 2 only starts determining the virtual lane 14 again based on the repeatedly updated lateral distance L1 between the ego-vehicle 1 and the preceding vehicle 13 when the second lateral threshold T4 (e.g., 0.4 meter) has been reached by increasingly approaching the second lateral threshold T4.

Hence, the control system 2 determines the virtual lane 14 based on a hysteresis, as there are two different lateral thresholds T3, T4 for the two cases of approaching the respective threshold T3, T4 in a decreasing manner or in an increasing manner, respectively.

In embodiments, the method comprises the step of determining, by the control system 2, a lateral speed v₁ of the preceding vehicle 13 based on sensor data from the sensor system 3. In FIG. 3, a vector v of the speed of the preceding vehicle 13 is shown. The speed vector v has a lateral component v₁ and a longitudinal component v₂. The control system 2 determines, in particular, an absolute value of the lateral component v₁ as the lateral speed v₁. Further, the control system 2 stops performing the lane keeping assistant function when the determined lateral speed v₁ is above a predetermined lateral speed threshold and/or the determined heading angle α of the preceding vehicle 13 is rapidly changing (e.g., a variation/speed of the heading angle α is above a predetermined threshold).

As illustrated in FIG. 4, the described method can also be applied to the case that more than one preceding vehicle 13, 22 and/or one or more following vehicles 23 on the same lane 12 as the ego-vehicle 1 are detected and taken into account for determining a virtual lane (such as the virtual lane 14, 14′ in FIGS. 2 and 3.

In the example of FIG. 4, there are two vehicles 13, 22 preceding the ego-vehicle 1 and one vehicle 23 following the ego-vehicle 1 present in a region of interest 24. The region of interest 24 is, for example, centered on the ego-vehicle 1 and has a predetermined width 25 (lateral direction) and a predetermined length 26 (longitudinal direction). Note that in FIG. 4, the region of interest 24 is only partly shown.

In the example of FIG. 4, the control system 2 detects in step S2 the two preceding vehicles 13, 22 and the one following vehicle 23 on the same lane 12 as the ego-vehicle 1 and in the predetermined region of interest 24 based on the sensor data S. In step S3, the control system 2 determines a virtual lane (not shown in FIG. 4 but similar as the virtual lane 14, 14′ in FIGS. 2 and 3) based on a heading angle α₁, α₂ of each of the two preceding vehicles 13, 22 and the one following vehicle 23 and based on a lateral distance L1₁, L1₂, L1₃ between the ego-vehicle 1 and each of the two preceding vehicles 13, 22 and the one following vehicle 23, respectively, derived from the sensor data S.

For example, the control system 2 determines the virtual lane based on a (e.g., weighted) mean value of the heading angles α₁, α₂ and based on a (weighted) mean value of the lateral distances L1₁, L1₂, L1₃. If weights are applied, they may be chosen such that a smaller lateral distance L1₁, L1₂, L1₃ corresponds to a higher weight. In the example of FIG. 4, the lateral distance L1₂ between the preceding vehicle 22 and the ego-vehicle 1 is smaller than the lateral distance L1₁ between the preceding vehicle 13 and the ego-vehicle 1. Hence, the heading angle α₂ and the lateral distance L1₂ of the preceding vehicle 22 may be taken into account with a higher weight than the heading angle α₁ and the lateral distance L1₁ of the preceding vehicle 13.

In embodiments, the control system 2 may also comprise a trained AI-device (artificial intelligence device) for determining the virtual lane 14, 14′. Furthermore, the control system 2 may also comprise an interface for a vehicle-to-vehicle communication (V2V communication) and/or for a vehicle-to-everything communication (V2X communication) to share the determined virtual lane 14, 14′ with control systems in an environment of the ego-vehicle 1, e.g., control systems of other vehicles such as the vehicles 13, 22, 23.

With the described method, a lane keeping assistant function can be provided also in cases in which no lane markings 11 are detected in the sensor data S by determining the virtual lane 14, 14′ based on the detected preceding vehicle 13 and possibly also based on further vehicles 22, 23 on the same lane 12. The virtual lane 14, 14′ is, in particular, determined such that the ego-vehicle 1 is not necessarily following the movements of the preceding vehicle(s) 13 (e.g., the heading angle α and the lateral position) exactly. Hence, when the preceding vehicle 13 is, for example, swerving, the ego-vehicle 1 may not follow this swerving movement, while still using the preceding vehicle 13 for generating the virtual lane 14, 14′. Therefore, a safety and a functionality of a lane keeping system can be improved.

Although the present invention has been described in accordance with preferred embodiments, it is obvious for the person skilled in the art that modifications are possible in all embodiments.

### LIST OF REFERENCE SIGNS

1 vehicle
2 control system
3 sensor system
4 sensor unit
5 sensor unit
6 sensor unit
7 sensor unit
8 surrounding
9 windscreen
10 road
11 lane marking
12 lane
13 vehicle
14,14′ virtual lane
15, 15′ center line
16 delineation
17 delineation
18 lateral position
19, 19′, 19″ lateral position
20 front end
21 back end
22 vehicle
23 vehicle
24 region of interest
25 width
26 length
27 receiving unit
28 detecting unit
29 determining unit
30 lane keeping unit
31 output unit
α angle
α₁ angle
α₂ angle
β angle
E width
I instruction
L1 lateral distance
L1₁ lateral distance
L1₂ lateral distance
L1₃ lateral distance
L2 lateral distance
M longitudinal distance
R1 direction
R2 direction
S sensor data
S1-S4 method steps
T1 threshold
T2 threshold
T3 threshold
T4 threshold
V speed
v₁ lateral speed
v₂ longitudinal speed
W lateral offset
X longitudinal direction
Y lateral direction

1. A method for operating an ego-vehicle,
the method comprising:
receiving sensor data of a sensor system of the ego-vehicle;
detecting an absence of lane markings and a presence of a preceding vehicle based on the sensor data;
determining a virtual lane based on a heading angle of the preceding vehicle and a lateral distance between the ego-vehicle and the preceding vehicle derived from the sensor data; and
performing a lane keeping assistant function to keep the ego-vehicle on the virtual lane.

2. The method according to claim 1,
wherein determining the virtual lane includes determining a center line of the virtual lane such that a lateral distance between the ego-vehicle and the center line has a value which is a fraction of the lateral distance between the ego-vehicle and the preceding vehicle.

3. The method according to claim 1,
wherein a longitudinal distance between the ego-vehicle and the preceding vehicle is determined based on the sensor data, and
wherein determining the virtual lane includes determining an angle of a center line of the virtual lane as a function of the heading angle of the preceding vehicle such that, for a longitudinal distance between the ego-vehicle and the preceding vehicle below a predetermined longitudinal threshold, the angle of the center line of the virtual lane is equal to the heading angle or to a first fraction of the heading angle of the preceding vehicle, and for a longitudinal distance between the ego-vehicle and the preceding vehicle equal to or above the predetermined threshold, the angle of the center line of the virtual lane is equal to a second fraction of the heading angle of the preceding vehicle,
wherein the second fraction is smaller than the first fraction.

4. The method according to claim 3,
wherein determining the virtual lane further includes determining the angle of the center line of the virtual lane as a function of the heading angle of the preceding vehicle such that for a longitudinal distance between the ego-vehicle and the preceding vehicle above a predetermined further longitudinal threshold, the angle of the center line of the virtual lane is equal to a third fraction of the heading angle of the preceding vehicle,
wherein the further longitudinal threshold is larger than the longitudinal threshold and the third fraction is smaller than the second fraction.

5. The method according to claim 1,
wherein determining the virtual lane includes:
determining a center line of the virtual lane such that a lateral distance between the ego-vehicle and the center line is a function of the lateral distance between the ego-vehicle and the preceding vehicle, and
determining left and right delineations of the virtual lane such that a lateral position of each of the left and right delineations is laterally offset from the center line in the left and right directions, respectively, by an offset value (W) that is based on the lateral distance between the ego-vehicle and the center line of the virtual lane.

6. The method according to claim 5,
wherein the offset value (W) is given by
$$W = min ( K , L 3 ) ,$$
wherein K is a predetermined value corresponding to half of a width of a standard lane, and L3 is a calculated lateral distance which is the sum of the lateral distance between the ego-vehicle and the center line of the virtual lane and a width of the ego-vehicle or a fraction of the width of the ego-vehicle.

7. The method according to claim 1,
wherein the lane keeping assistant function is performed such that:
determining the virtual lane is repeatedly performed to keep the ego-vehicle on the repeatedly updated virtual lane,
determining the virtual lane is repeatedly performed based on a repeatedly updated heading angle of the preceding vehicle and a repeatedly updated lateral distance between the ego-vehicle and the preceding vehicle determined from repeatedly received sensor data until the determined lateral distance between the ego-vehicle and the preceding vehicle has decreased to a predetermined lateral threshold, and then
determining the virtual lane is repeatedly performed based on a repeatedly updated heading angle of the preceding vehicle and a lateral distance between the ego-vehicle and the preceding vehicle is equal to the predetermined lateral threshold.

8. The method according to claim 7,
wherein, when the determined lateral distance between the ego-vehicle and the preceding vehicle is increasingly reaching a further predetermined lateral threshold, determining the virtual lane is started again based on the repeatedly updated heading angle of the preceding vehicle and the repeatedly updated lateral distance between the ego-vehicle and the preceding vehicle determined from the repeatedly received sensor data,
wherein the further predetermined lateral threshold is larger than the predetermined lateral threshold.

9. The method according to claim 1,
wherein a lateral speed of the preceding vehicle is determined based on the sensor data, and
wherein performing the lane keeping assistant function is stopped when the determined lateral speed is above a predetermined lateral speed threshold or a variation of the heading angle of the preceding vehicle is above a predetermined threshold.

10. The method according to claim 1,
wherein more than one preceding vehicle or one or more following vehicles on the same lane as the ego-vehicle and in a predetermined region of interest are detected based on the sensor data, and
wherein the virtual lane is determined based on a heading angle of each of the more than one preceding vehicles or the one or more following vehicles and based on a lateral distance between the ego-vehicle and each of the more than one preceding vehicles or the one or more following vehicles derived from the sensor data.

11. The method according to claim 10,
wherein the virtual lane is determined based on a mean value or a weighted mean value of the heading angles of the more than one preceding vehicles or the one or more following vehicles and based on a mean value or a weighted mean value of the lateral distances between the ego-vehicle and each of the more than one preceding vehicles or the one or more following vehicles derived from the sensor data.

12. The method according to claim 11,
wherein the weights applied for determining the weighted mean value of the heading angles or of the lateral distances are chosen such that a smaller lateral distance corresponds to a higher weight.

13. A non-transitory computer readable medium comprising program instructions which, when executed by a computer, cause the computer to carry out the method according to claim 1.

14. A control system for a vehicle which is configured to perform the method according to claim 1.

15. A vehicle with a control system according to claim 14.
